(19) United States
(12) Patent Application Publication
(10) Pub. No.: US 2014/0190719 A1
(43) Pub. Date: Jul. 10, 2014

(54) DOUBLE-VALVE MECHANISM

(71) Applicant: HYPHONE MACHINE INDUSTRY CO., LTD., Taichung City (TW)

(72) Inventors: Chih-Ming TING, Taichung City (TW); Tien LIN, Taichung City (TW); Po-Jen LAI, Taichung City (TW)

(73) Assignee: HYPHONE MACHINE INDUSTRY CO., LTD., Taichung City (TW)

(21) Appl. No.: 13/734,167

(22) Filed: Jan. 4, 2013

(51) Int. Cl. B25F 5/00; F16K 11/14

(52) U.S. Cl. CPC B25F 5/00; F16K 11/14
USPC 173/221; 137/596.18

(57) ABSTRACT

A double-valve mechanism and a pneumatic tool including the same are provided. The double-valve mechanism is mounted in a main body of the pneumatic tool. The main body has an exhausting passage and an outlet passage communicating therewith, and an entrance passage and an inlet passage communicating therewith. The double-valve mechanism is operable from outside of the main body to move relative to the main body so as to selectively seal an entry of the inlet passage and an exit of the outlet passage. Whereby, the stop of the tool is effectively ensured after the double-valve mechanism is closed, no gas leakage will occurs, the waste of pressurized air energy and defects of the tool will be avoided, and the rotation of the rotor can be quickly stopped.

### BACKGROUND OF THE INVENTION

1. Field of the Invention

The present invention relates to a double-valve mechanism, more particularly, to a double-valve mechanism which has entrance and exhaust control vales and a pneumatic tool including the same.

2. Description of the Prior Art

In a conventional pneumatic tool, a pneumatic motor is used to drive a working tool so as to drive a workpiece rotating or proceed machining, processing or the like. An air wrench like a kind of the above conventional pneumatic tool is disclosed in U.S. Pat. No. 5,901,794.

In a conventional pneumatic tool like the kind of the above conventional one, the pneumatic motor is driven by pressurized air, in which the pressurized air enters into the pneumatic tool via an inlet passage to drive the pneumatic motor rotating and then exhausts outside the pneumatic tool via an exhaust passage.

However, the exhaust passage of the conventional pneumatic tool is not sealed; the pneumatic rotor can still rotate due to its rotation inertia even though the entry of an inlet passage has been sealed, so that the rotating rotor cannot be stopped quickly and instantly. As such, a work such as screwing or unscrewing cannot be carried out precisely and over-screw or tooth collapse, and injury to the user, may be caused.

US 2007/0007023 is directed to a rotatable pneumatic power tool and method for quickly stopping rotation of the same. The rotatable pneumatic power tool has a throttle valve located within the outlet passageway and adjustable between a fully closed position and an open position. With the throttle valve open, the tool operates with air flowing through the motor and, when the throttle valve is closed, the exhaust air is blocked and the rotation of the motor quickly stops because, not only is the air supply discontinued but, furthermore, the pressurized air surrounding the motor provides a significant drag upon the rotation of the motor, thereby promoting significant deceleration to stop the rotation.

However, the throttle valve can block only the exhaust air but cannot block the entering air. Since the throttle valve blocks only the exhaust air, gas leakage might occur due to tolerances between parts inside the tool, due to the tolerance between the entrance adaptors, or due to the tolerance of assembly of a cylinder. The gas leakage causes a waste of energy and defects of the tool, and will cause noise and degradation of the output torsion of the tool. The gas leakage occurring due to the tolerance of assembly of the cylinder can further cause rotation of the tool after the exhaust air has been blocked by the throttle valve, which can cause injury to the user.

The present invention is, therefore, arisen to obviate or at least mitigate the above mentioned disadvantages.

### SUMMARY OF THE INVENTION

An object of the present invention is to provide a double-valve mechanism and a pneumatic tool including the same, in which the double-valve mechanism can block both the exhaust and entrance air so that pressurized air is completely blocked and the stop of the tool is more effectively ensured after the double-valve mechanism is closed, which is better than that in using only an entrance or exhaust control vale; gas leakage, due to tolerances between parts inside the tool, due to the tolerance between the entrance adaptors, or due to the tolerance of assembly of a cylinder, will not occur. As a result, the waste of pressurized air energy and defects of the tool will be avoided. Furthermore, since no gas leakage occurs, none of noise and degradation of the output torsion of the tool is caused, and rotation of the tool, after the exhaust and entrance air has been blocked, is effectively avoided so that injury to the user can be prevented. Additionally, with the exhaust and entrance air is blocked, the rotation of the rotor can be quickly stopped, and over-screw and tooth collapse can be prevented.

To achieve the above and other objects, a double-valve mechanism is adapted to mount in a main body of a pneumatic tool. The main body includes an exhaust passage, an outlet passage, an entrance passage and an inlet passage. The exhaust passage is adapted for exhausting air outside. The outlet passage and the exhaust passage are communicated. The entrance passage and the inlet passage are communicated. An entrance control vale of the double-valve mechanism is located between the entrance and inlet passages, and an exhaust control vale of the double-valve mechanism is located between the outlet and exhaust passages. The double-valve mechanism is operable from outside of the main body to move the entrance control vale and the exhaust control vale in a single operation. The double-valve mechanism is movable relative to the main body so as to selectively seal an entry of the inlet passage via the exhaust control vale and seal an exit of the outlet passage via the exhaust control vale so that the inlet and outlet passages are pneumatically uncommunicated with the entrance and exhaust passages respectively.

To achieve the above and other objects, a pneumatic tool includes the above double-valve mechanism, a main body, a rotor and a tool assembly. The main body includes a cylinder, an exhaust passage and an outlet passage. The cylinder is formed with a chamber. The chamber is pneumatically communicated with the exhaust passage and the outlet passage. The exhaust passage is adapted for exhausting air outside. The rotor is rotatably disposed in the cylinder and received in the chamber. The tool assembly is rotatably received in the main body and in a rotational cooperative relationship with the rotor.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a first preferred embodiment of the present invention;

FIG. 2 is a partial breakdown drawing of the first preferred embodiment of the present invention;

FIG. 3 is a cross-sectional view of the first preferred embodiment of the present invention;

FIG. 4 is a view showing a pneumatic tool including a double-valve mechanism in use according to the first preferred embodiment of the present invention;

FIG. 5 is a cross-sectional view showing the double-valve mechanism according to the first preferred embodiment of the present invention;

FIG. 6 is a partial breakdown drawing of a second preferred embodiment of the present invention;

FIG. 7 is a cross-sectional view of the second preferred embodiment of the present invention;

FIG. 8 is a view showing a pneumatic tool including a double-valve mechanism in use according to the second preferred embodiment of the present invention;

FIG. 9 is a partial breakdown drawing of a third preferred embodiment of the present invention;

FIG. 10 is a cross-sectional view of the third preferred embodiment of the present invention;

FIG. 11 is a view showing a pneumatic tool including a double-valve mechanism in use according to the third preferred embodiment of the present invention;

FIGS. 12 to 14 are schematic drawings of a fourth preferred embodiment of the present invention; and

FIGS. 15 to 18 are schematic drawings of a fourth preferred embodiment of the present invention.

### DETAILED DESCRIPTION OF THE PREFERRED EMBODIMENTS

The present invention relates a double-valve mechanism which is adapted to mount in a main body of a pneumatic tool. The main body at lest includes an exhaust passage and an outlet passage, in which the exhaust passage is adapted for exhausting air outside. The outlet passage and the exhaust passage are communicated. The double-valve mechanism is movable relative to the main body so as to at lest seal an exit of the outlet passage.

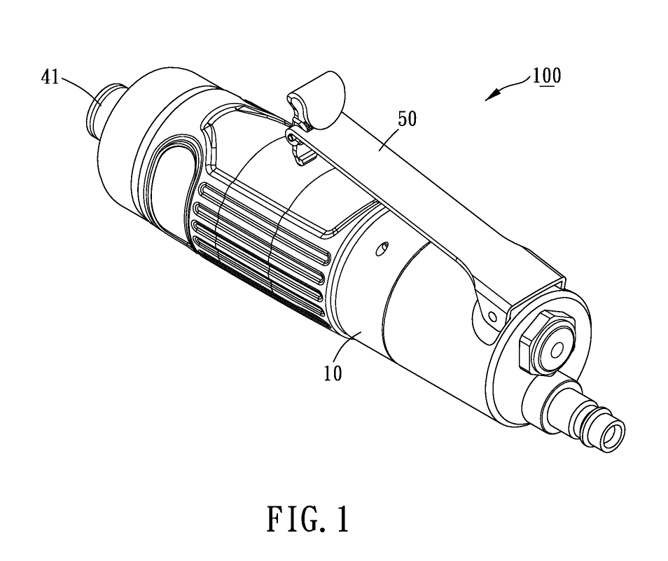

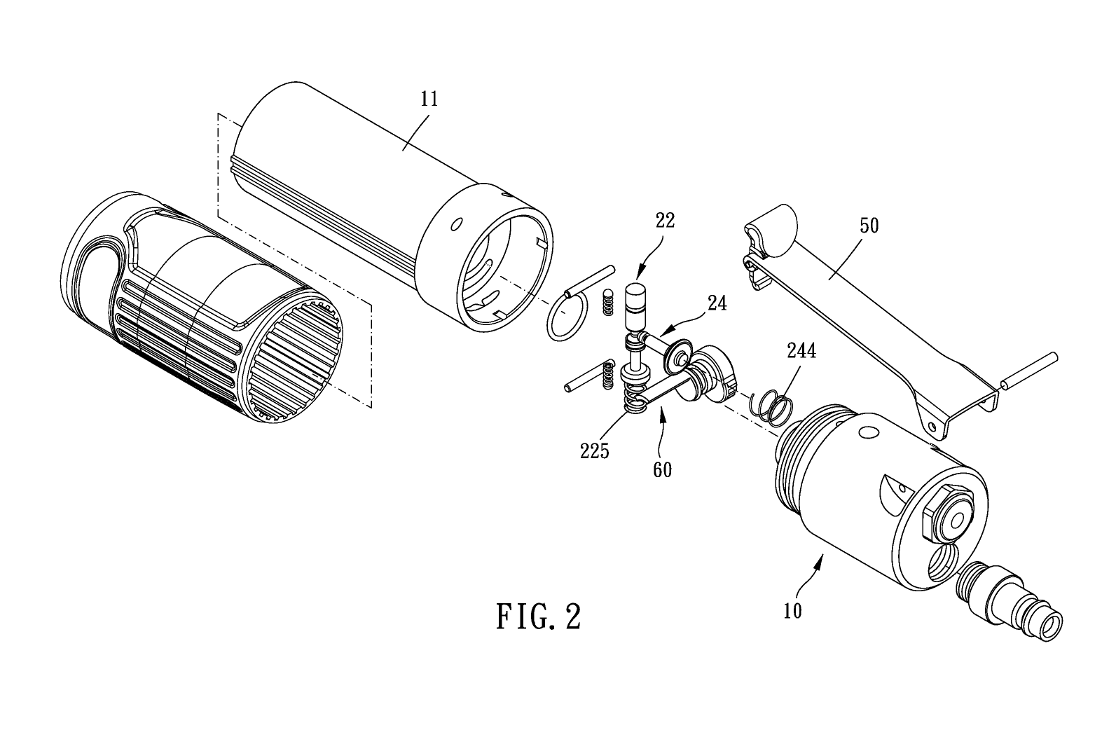

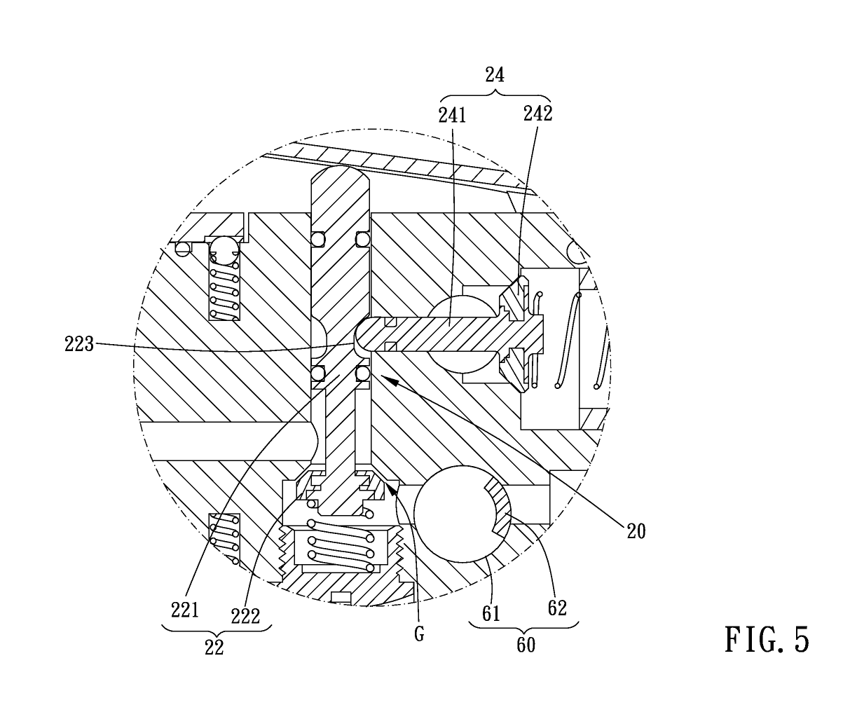

FIGS. 1 to 5 show a double-valve mechanism 20 (FIG. 5) and a pneumatic tool 100 including the double-valve mechanism 20 according to a first preferred embodiment of the present invention. The pneumatic tool 100 includes a main body 10, a double-valve mechanism 20, a rotor 30 and a tool assembly 40. The pneumatic tool 100 such as, but is not limited to, an air screwdriver, air wrench, air drill, air pull setter, or air sander.

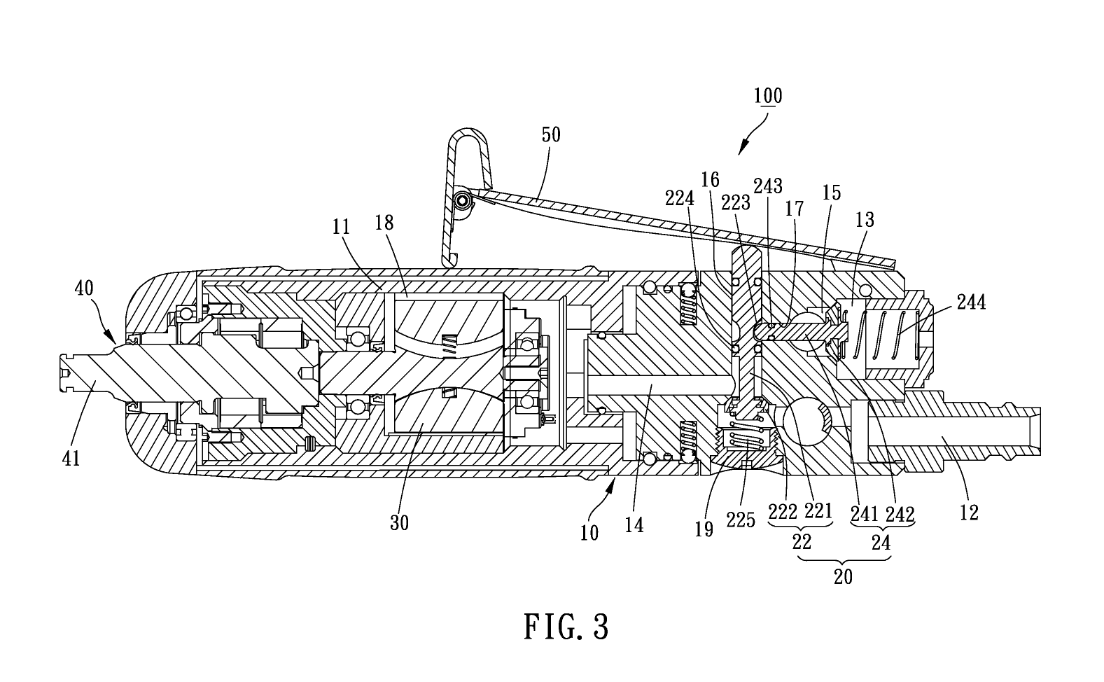

As shown in FIGS. 3 to 5, the main body 10 includes a cylinder 11, an entrance passage 12, an exhaust passage 13, an inlet passage 14, an outlet passage 15, a first receiving hole 16 and a second receiving hole 17. The cylinder 11 is formed with a chamber 18. The entrance passage 12 is adapted for entering a pressurized air, and the exhaust passage 13 is adapted for exhausting the pressurized air outside. The chamber 18 is pneumatically communicated with the inlet passage 14 and the outlet passage 15. The second receiving hole 17 is formed between the first receiving hole 16 and the outlet passage 15 and communicated with the first receiving hole. In this embodiment, the second receiving hole 17 is arranged substantially perpendicular to the first receiving hole 16.

The first receiving hole 16 is, here, a through hole, and a cover 19 is detachably mounted over an opening of the first receiving hole 16. It is noted that the cover 19 may be considered as a part of the main body 10. In this embodiment, an inner surface in the first receiving hole 16 is formed with an inner thread, and the cover 19 is formed with an outer thread for screwing with the inner thread. The top of the cover 19 may be formed with a recess for engagement of the cover 19 with or disengagement of the cover 19 from the main body 10.

The double-valve mechanism 20 includes an entrance control vale 22 and an exhaust control vale 24 which is co-movable with the entrance control vale 22, and operable from outside of the main body 10 via moving the entrance control vale 22. That is, the double-valve mechanism 20 is operable from outside of the main body 10 to move the entrance control vale 22 and the exhaust control vale 24 in a single operation of the double-valve mechanism 20.

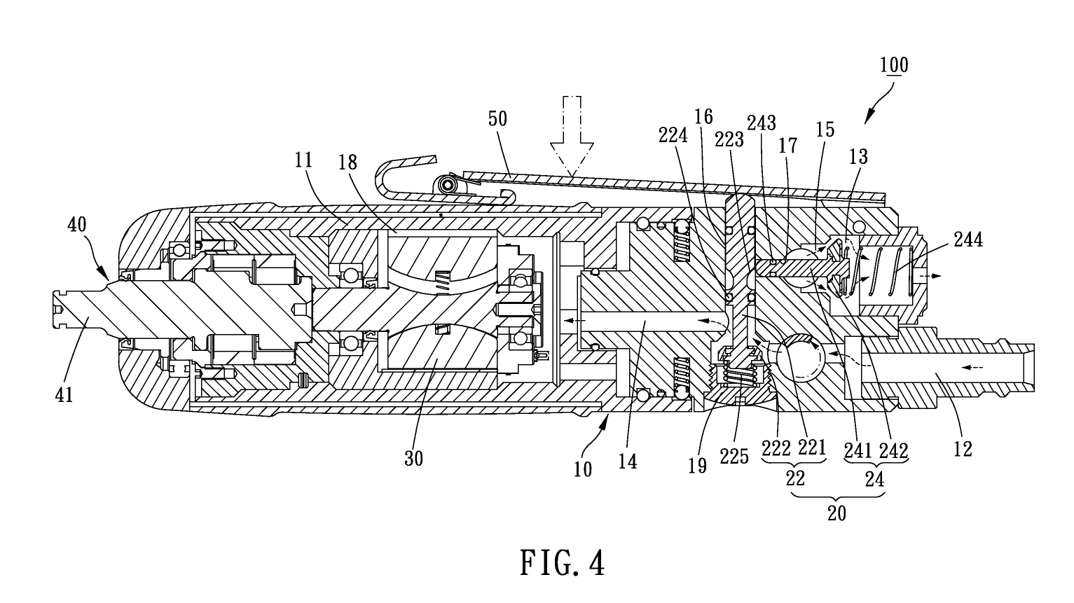

The entrance control vale 22 is located between the entrance passage 12 and the inlet passage 14, movably disposed through the first receiving hole 16 and axially movable between a first position (as shown in FIG. 3) and a second position (as shown in FIG. 4), and in a substantially gastightly-sealed relationship with a circumferential surface in the first receiving hole 16. One end of the entrance control vale 22 extends from an opening of the first receiving hole 16 to outside the main body 10 and the other end thereof selectively seals an entry of the inlet passage 14. More specifically, the entrance control vale 22 includes an inlet rod 221 and an inlet plug 222 disposed at one end of the inlet rod 221. The inlet rod 221 is disposed through the first receiving hole 16 and radially formed with an arcuate recess 223 (annular groove) on a circumferential surface thereof. The inlet plug 222 can selectively seal the entry of the inlet passage 14. The entrance control vale 22 is in a substantially gastightly-sealed relationship with the circumferential surface in the first receiving hole 16 via at lest one O-ring 224 disposed around the inlet rod 221. In this embodiment, two of the O-rings 224 are located by two sides of the recess 223. It is noted that since the cover 19 is detachably mounted over the opening of the first receiving hole 16, it is easy to maintain or replace the entrance control vale 22. A first elastic member 225 is disposed between the entrance control vale 22 and the cover 19, and the first elastic member 225 is preferably a spiral spring and two ends thereof abut respectively against the entrance control vale 22 and the cover 19, so that the first elastic member 225 urges the entrance control vale 22 to seal the entry of the inlet passage 14.

The exhaust control vale 24 is located between the exhaust passage 13 and the outlet passage 15, movably disposed through the second receiving hole 17. One end of the exhaust control vale 24 and the entrance control vale 22 are co-movable and the other end of the exhaust control vale 24 can selectively seal the exit of the outlet passage 15. More specifically, the exhaust control vale 24 includes an outlet rod 241 and an outlet plug 242 disposed at one end of the outlet rod 241. The outlet rod 241 is disposed through the second receiving hole 17 and one end thereof substantially perpendicularly abuts against the entrance control vale 22; however, the outlet rod 241 may be not abutted against the entrance control vale 22. The outlet plug 242 can selectively seal the exit of the outlet passage 15. The exhaust control vale 24 is in a substantially gastightly-sealed relationship with the circumferential surface in the second receiving hole 17 via at lest one O-ring 243 disposed around the outlet rod 241. A second elastic member 244 is disposed between the exhaust control vale 24 and the main body 10. More specifically, the second elastic member 244 is preferably a spiral spring and two ends thereof abut respectively against the exhaust control vale 24 and the main body 10, so that the second elastic member 244 urges the exhaust control vale 24 to seal the exit of the outlet passage 15. Preferably, a cover with an axial through hole is detachably mounted to an inner surface of the exhaust passage 13 (the cover may be considered as a part of the main body 10), and the second elastic member 244 abuts between the outlet plug 242 and the cover, so that it is easy to maintain, assemble or replace the exhaust control vale 24.

The rotor 30 is rotatably disposed in the cylinder 11 and received in the chamber 18. The cylinder 11 can lead the pressurized air to flow into the chamber 18 to drive the rotor 30 rotating, and then the pressurized air goes out from the chamber 18 via the outlet passage 15.

The tool assembly 40 is rotatably received in the main body 10 and in a rotational cooperative relationship with the rotor 30. More specifically, the tool assembly 40 is received in a tool receiving space of the main body 10 and rotatable relative to the main body 10. The tool assembly 40 may include a tool head 41 extending out of the main body 10 for a connection of the tool head 41 with a workpiece or a tool. The tool assembly 40 is connected to and in a rotational cooperative relationship with the rotor 30. In an alternative embodiment, the tool assembly 40 may be replaced by any other tool assembly which can drive the workpiece or the tool.

In this embodiment, a lever 50 is pivoted to the main body 10 for pressing the entrance control vale 22, wherein the lever 50 may be replaced by any equivalent member such as, but is not limited to, button member.

Preferably, an open/close control assembly 60 is located in the main body 10 and in the entrance passage 12 for selectively interdicting or uninterdicting the entrance passage 12, so as to unpermit or permit entering or exhaust of the pressurized air. The open/close control assembly 60 includes a shaft 61 rotatable relative to the main body 10 and a block portion 62 connected to the shaft 61. The shaft 61 is adapted for being selectively rotated by an user to drive the block portion 62 to interdict or uninterdict the entrance passage 12. The open/close control assembly 60 may be replaced by any structure which can selectively interdict or uninterdict the entrance passage 12. For example, the block portion 62 may be a ball-shaped body which can eccentrically rotate.

In use of the pneumatic tool 100, when the lever 50 is not depressed, the entrance control vale 22 is urged by the first elastic member 225 and located in the first position and the entrance control vale 22 seals the entry of the inlet passage 14 so that the entrance passage 12 is pneumatically uncommunicated with the inlet passage 14, and the exhaust control vale 24 is urged by the second elastic member 244 to seal the exit of the outlet passage 15 so that the exhaust passage 13 is pneumatically uncommunicated with the outlet passage 15. More specifically, when the entrance control vale 22 is located in the first position, one end of the outlet rod 241 reaches into or blocked in the recess 223 and the inlet plug 222 and the outlet plug 242 respectively seal the entry of the inlet passage 14 and the exit of the outlet passage 15 (as shown in FIG. 3).

When the lever 50 is depressed to push one end of the inlet rod 221 which is outside the main body 10, the entrance control vale 22 moves from the first position toward the second position, the inlet plug 222 which engages with the periphery surface of the inlet passage 14 moves downwardly and away from and unseals the entry of the inlet passage 14 so that the entrance passage 12 and the inlet passage 14 are pneumatically communicated and one end of the outlet rod 241 is urged by the recess 223 to move along the surface of the recess 223 away from the inlet rod 221. The outlet plug 242 which engages with the periphery surface of the outlet passage 15 moves rightward and away from and unseals the exit of the outlet passage 15 so that the exhaust passage 13 and the outlet passage 15 are pneumatically communicated. As such, the entrance passage 12, the inlet passage 14, the chamber 18, the outlet passage 15 and the exhaust passage 13 are pneumatically communicated. Thus, the pressurized air can flow into the chamber 18 via the entrance passage 12 and the inlet passage 14 to drive the rotor 30 rotating so as to drive the tool assembly 40 rotating, and the pressurized air then exhausts outside via the exhaust passage 13. It is noted that the outlet rod 241 and the recess 223 may be correspondingly modified, in which the inlet passage 14 may be unsealed in advance while the outlet passage 15 is unsealed thereafter; alternatively, the outlet passage 15 may be unsealed in advance while the inlet passage 14 is unsealed thereafter; alternatively, the outlet passage 15 and the inlet passage 14 may be unsealed simultaneously. When the entrance control vale 22 is located in the second position, one end of the outlet rod 241 abuts against a surface of the inlet rod 221 out of the recess 223, and the gap between the inlet plug 222 and the periphery surface of the inlet passage 14 and the gap between the outlet plug 242 and the periphery surface of the outlet passage 15 are relatively the greatest (as shown in FIG. 4), so that the flow rate of the pressurized air for driving the rotor 30 is therefore the greatest and the power output of the pneumatic tool 100 is the greatest.

As shown in FIGS. 3 and 4, when the lever 50 is released, the entrance control vale 22 can move from the second position toward the first position, one end of the outlet rod 241 abutting against the surface out of the recess 223 moves in the recess 223 and is not pushed by the inlet rod 221 so that the outlet plug 242 seals the exit of the outlet passage 15. Preferably, according to different designs, when the outlet plug 242 seals the exit of the outlet passage 15, the inlet plug 222 and the periphery surface of the inlet passage 14 may form a gap G about 0.3 mm in width (as shown in FIG. 5), the entrance control vale 22 keeps moving toward the first position and the inlet plug 222 then seals the entry of the inlet passage 14. However, when the outlet plug 242 seals the exit of the outlet passage 15, the inlet plug 222 may seal the entry of the inlet passage 14 simultaneously.

Conventionally, as the outlet passage is unsealed, the rotor can still rotate due to its rotation inertia even though the entry of the inlet passage have been sealed, so that the rotating rotor does not be stopped quickly and instantly, and thus a work such as screwing or unscrewing cannot be carried out precisely and over-screw or tooth collapse, and injury to the user, may be caused. In the invention, since the exit of the outlet passage 15 is sealed in advance, the pressurized air in the chamber 18 will drag the rotor 30 first and the flow path of the pressurized air is then blocked so that the pressurized air cannot exhaust outside. Additionally, since the double-valve mechanism 20 can block both the exhaust and entrance air, the pressurized air is completely blocked and the stop of the tool is more effectively ensured than that in using only an entrance or exhaust control vale; gas leakage, due to tolerances between parts inside the tool, due to the tolerance between the entrance adaptors, or due to the tolerance of assembly of a cylinder, will not occur. As a result, the waste of pressurized air energy and defects of the tool will be avoided. Furthermore, since no gas leakage occurs, none of noise and degradation of the output torsion of the tool is caused, and rotation of the tool, after the exhaust and entrance air has been blocked, is effectively avoided so that injury to the user can be prevented. Additionally, with the exhaust and entrance air is completely blocked, the rotation of the rotor 30 can be quickly stopped, and over-screw and tooth collapse can be prevented.

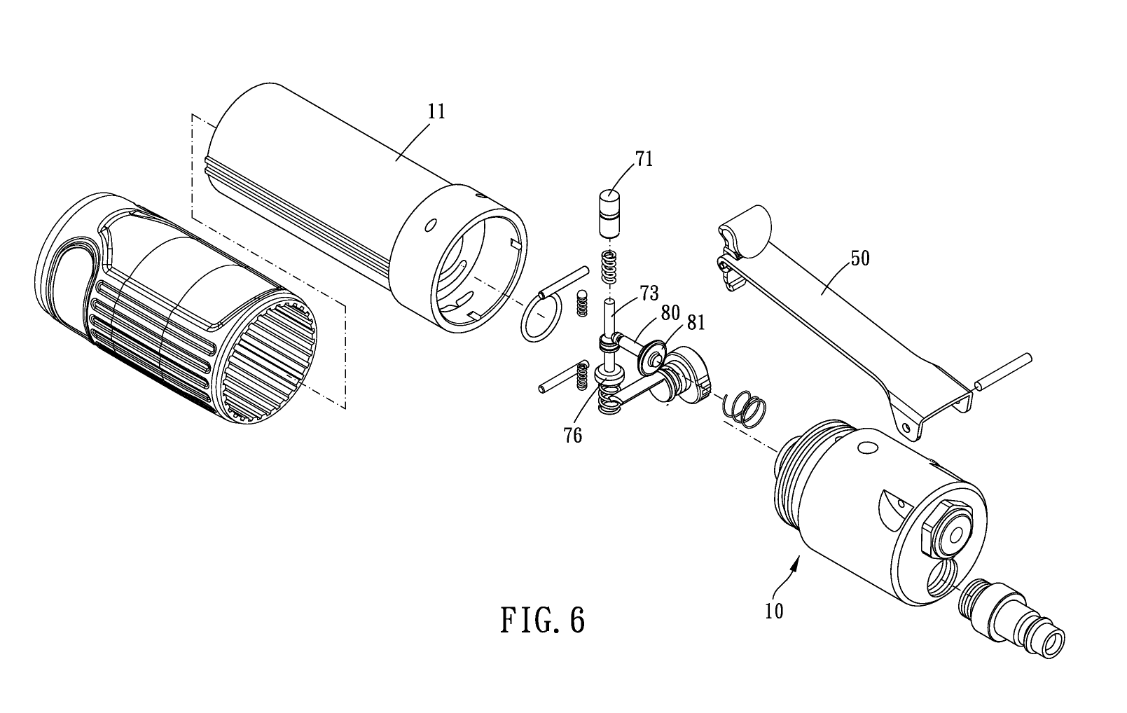

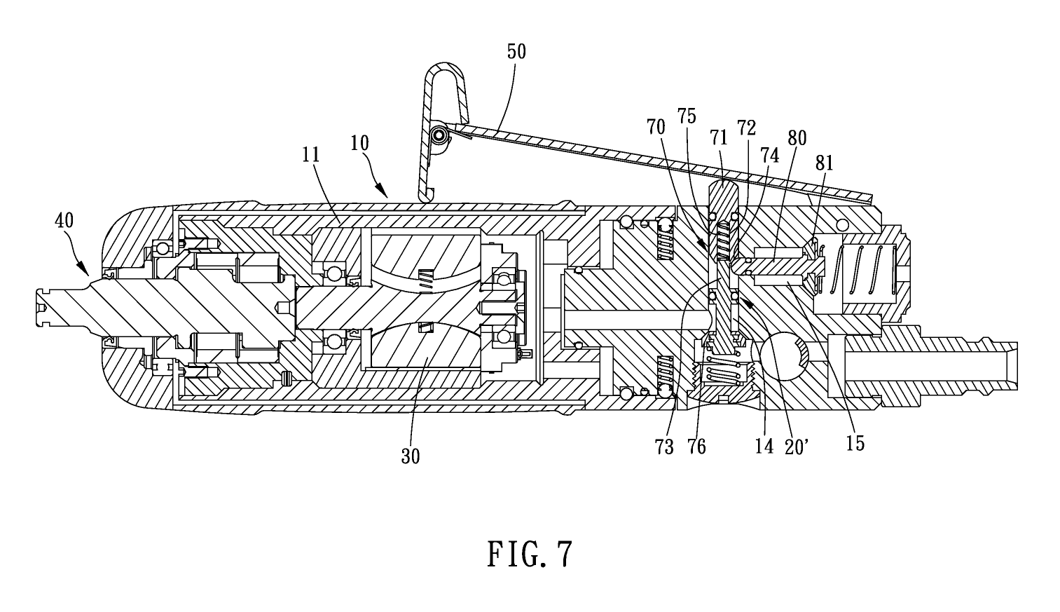

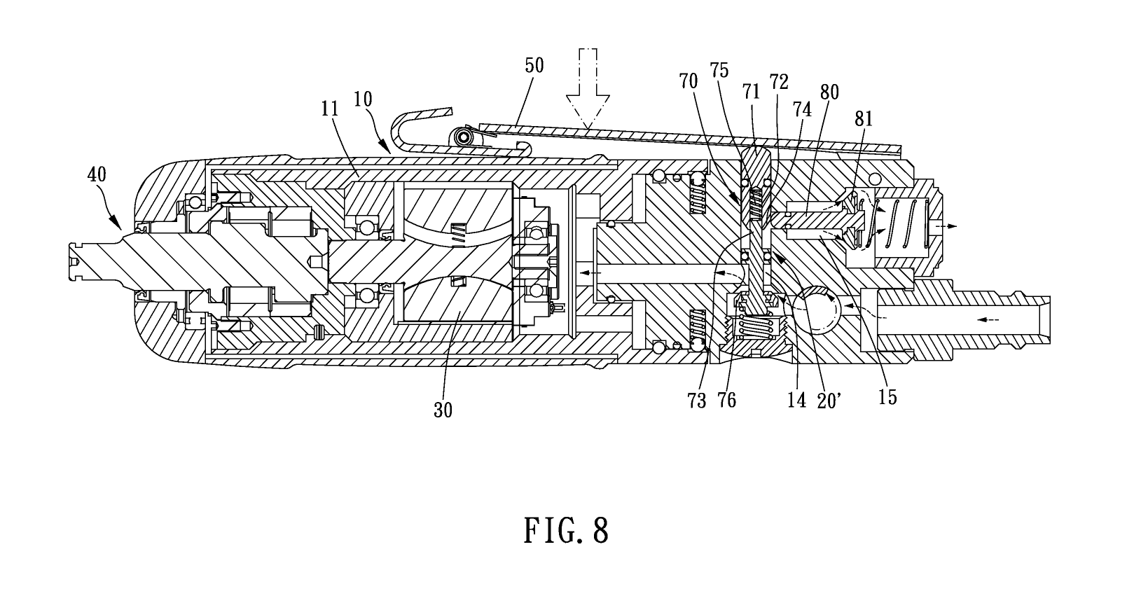

It is noted that, in a second preferred embodiment as shown in FIGS. 6 to 8, an inlet rod 70 of a double-valve mechanism 20′ includes a head portion 71 having a hole 72 and a body portion 73 whose one end is received in the hole 72. One end of the head portion 71 extends outside the main body 10 and the other end thereof includes a necked section 74. A third elastic member 75 is disposed in the hole 72 and between the head portion 71 and the body portion 73. When the entrance control vale of the double-valve mechanism 20′ is moved from the first position (FIG. 7) toward the second position (FIG. 8), the outlet rod 80 which abuts against the surface out of the necked section 74 slides in and along the necked section 74 and the outlet rod 80 moves toward the inlet rod 70 so that the outlet plug 81 seals the exit of the outlet passage 15 in advance. The inlet rod 70 keeps moving toward the first position, and the inlet plug 76 then seals the entry of the inlet passage 14. Whereby, the advantages like those in the first preferred embodiment can also be achieved.

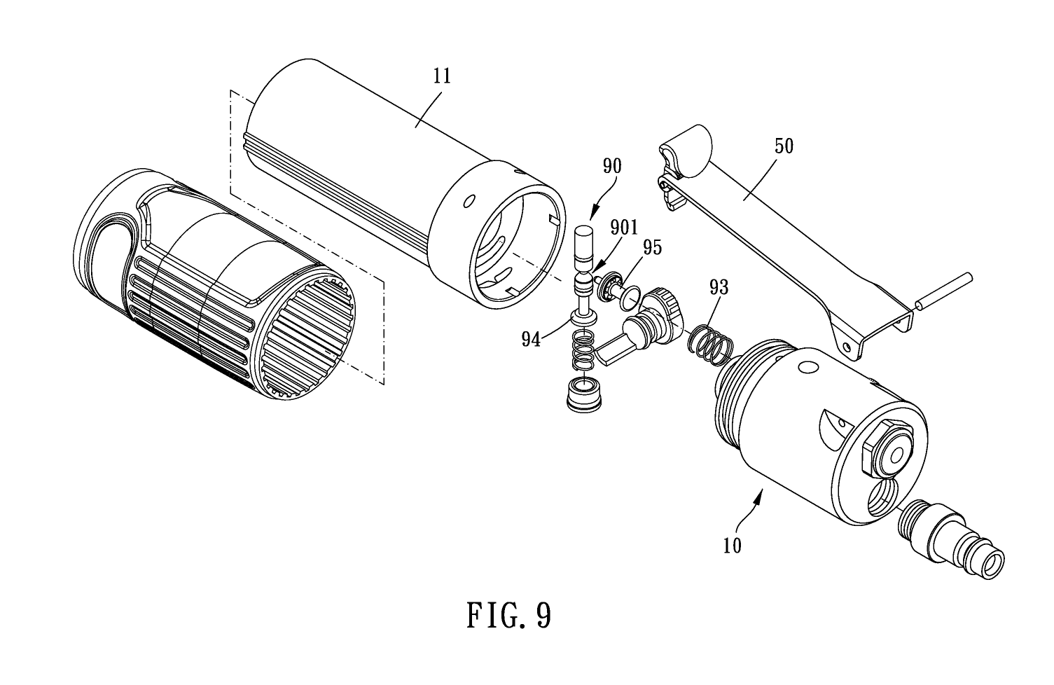

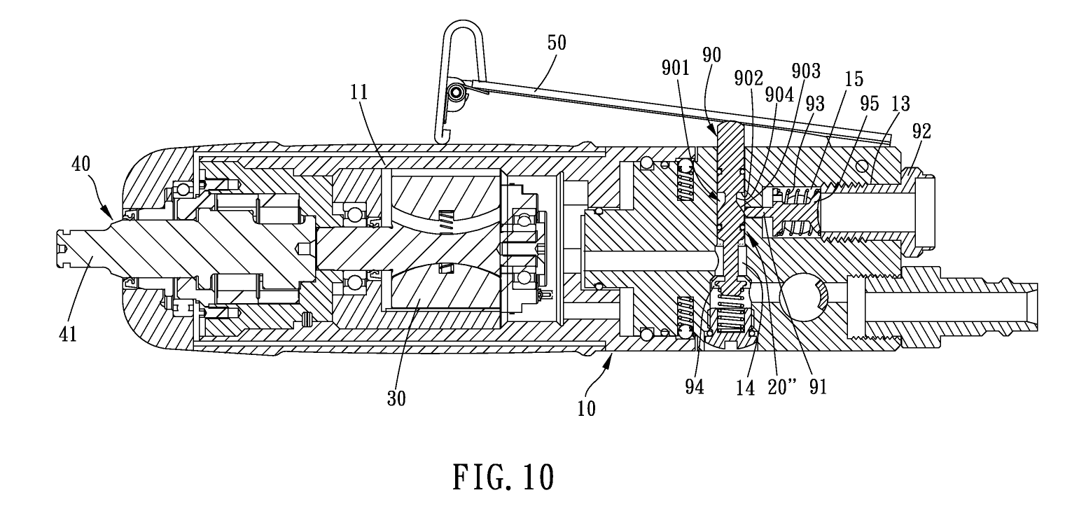

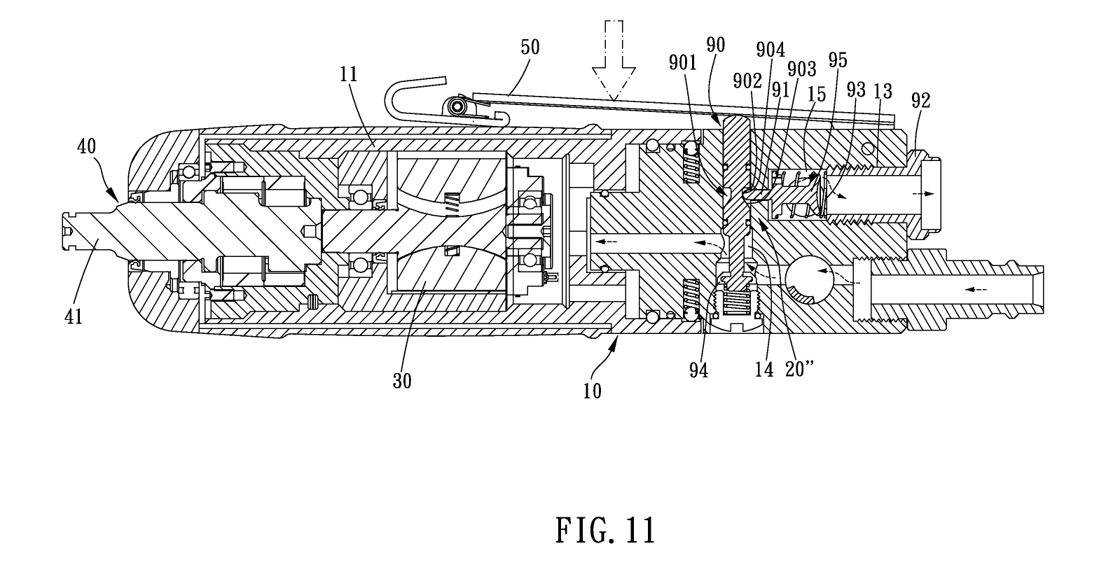

In a third preferred embodiment as shown in FIGS. 9 to 11, a recess 901 of an inlet rod 90 of a double-valve mechanism 20″ includes a radially-extending surface 902, a slant surface 903 and a bottom surface 904 connected between the radially-extending surface 902 and the slant surface 903. An outlet rod 91 is radially formed with an abutting portion 911 between two ends thereof. The abutting portion 911 may include an through hole, and a screw member 92 having an axial through hole is screwed to the inner surface of the exhaust passage 13 (the screw member 92 may be considered as a part of the main body), and a second elastic member 93 is disposed between the abutting portion 911 and the screw member 92. When the entrance control vale of the double-valve mechanism 20″ is located in the first position (FIG. 10), one end of the outlet rod 91 abuts against a periphery portion of the opening of the recess 901, and an inlet plug 94 and an outlet plug 95 respectively seal the entry of the inlet passage 14 and the exit of the outlet passage 15. When the entrance control vale moves from the first position toward the second position (FIG. 11), the second elastic member 93 urges the abutting portion 911 so as to force one end of the outlet rod 91 to move along the slant surface 903 and reach into the recess 901, and the inlet plug 94 and the outlet plug 95 respectively unseal the entry of the inlet passage 14 and the exit of the outlet passage 15. When the entrance control vale is located in the second position, one end of the outlet rod 91 is blocked by the radially-extending surface 902. Whereby, the advantages like those in the first preferred embodiment can also be achieved.

In a double-valve mechanism such as one in any of the aforementioned embodiments according to the invention, the entrance passage and the exhaust passage are up-down arranged; however, they may be left-right arranged in an alternative embodiment by changing the arrangement of the entrance passage and the exhaust passage.

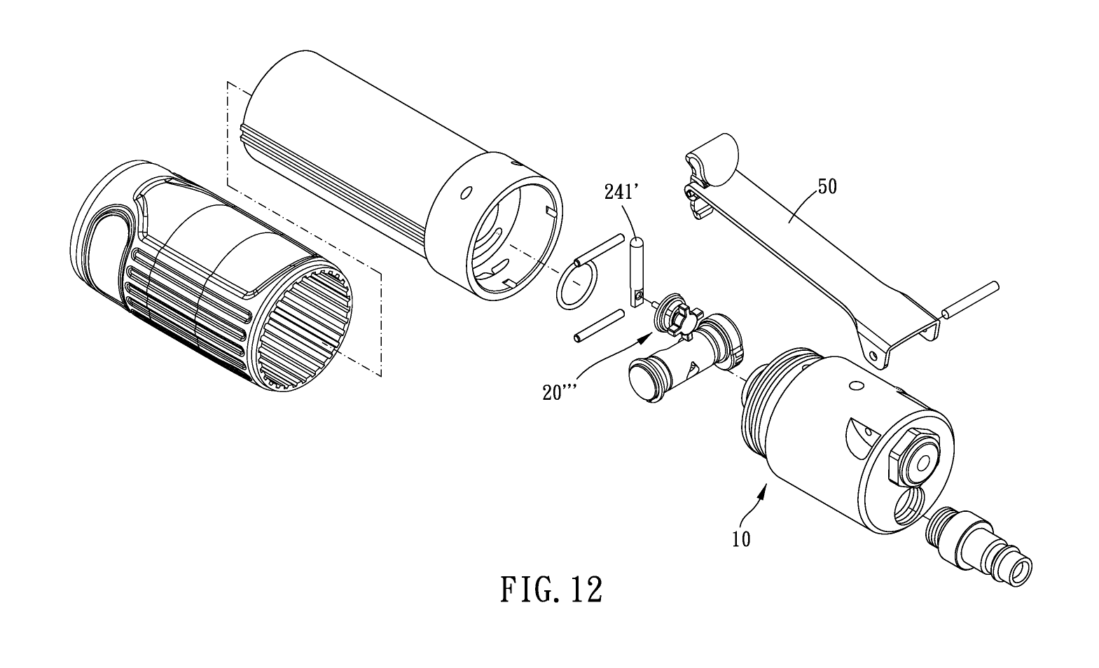

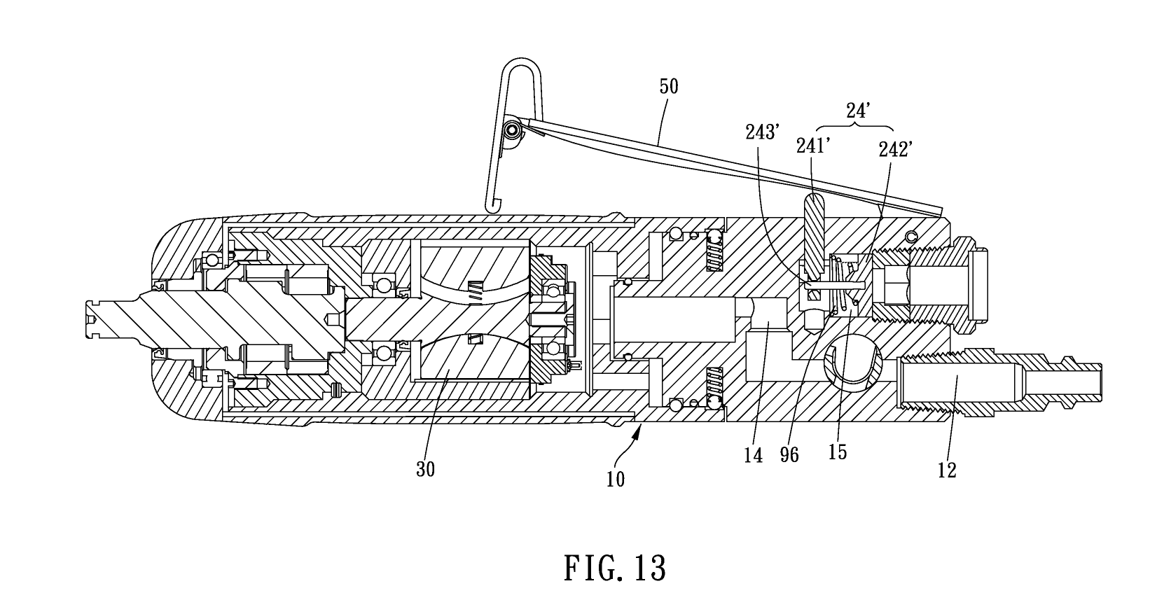

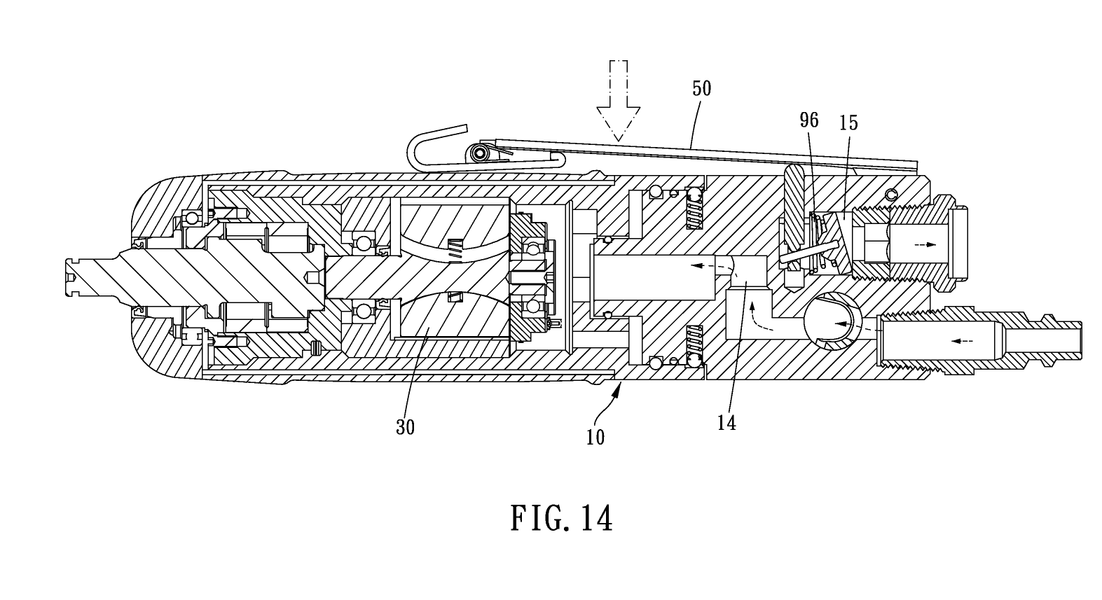

FIGS. 12 to 14 show a double-valve mechanism according to a fourth preferred embodiment of the present invention. In this embodiment, the double-valve mechanism 20′″ includes merely an exhaust control vale 24′ without an entrance control vale. In other words, the inlet passage 14 and the entrance passage 12 are directly communicated with each other. The exhaust control vale 24′ include an outlet rod 241′ and an outlet plug 242′. The outlet rod 241′ is radially disposed through the main body 10 and movable between a third position and a fourth position. The outlet plug 242′ and the outlet rod 241′ are in a co-movable relationship. More specifically, the outlet plug 242′ and the outlet rod 241′ are co-movable via a linkage rod 243′. A fourth elastic member 96 is disposed in the outlet passage 15 and located between the outlet rod 241′ and the outlet plug 242′. The fourth elastic member 96 urges the outlet plug 242′ to move toward the exit of the outlet passage 15 so as to seal the exit of the outlet passage 15. When the outlet rod 241′ is located in the third position, the outlet plug 242′ seals the exit of the outlet passage 15; when the outlet rod 241′ moves from the third position toward the fourth position, the outlet plug 242′ unseals the exit of the outlet passage 15. As such, it needs only to press or release the exhaust control vale 24′ to unseal or seal the exit of the outlet passage 15. Whereby, through that the exhaust control vale 24′ seals the exit of the outlet passage, the rotation of the rotor 30 can be quickly stopped.

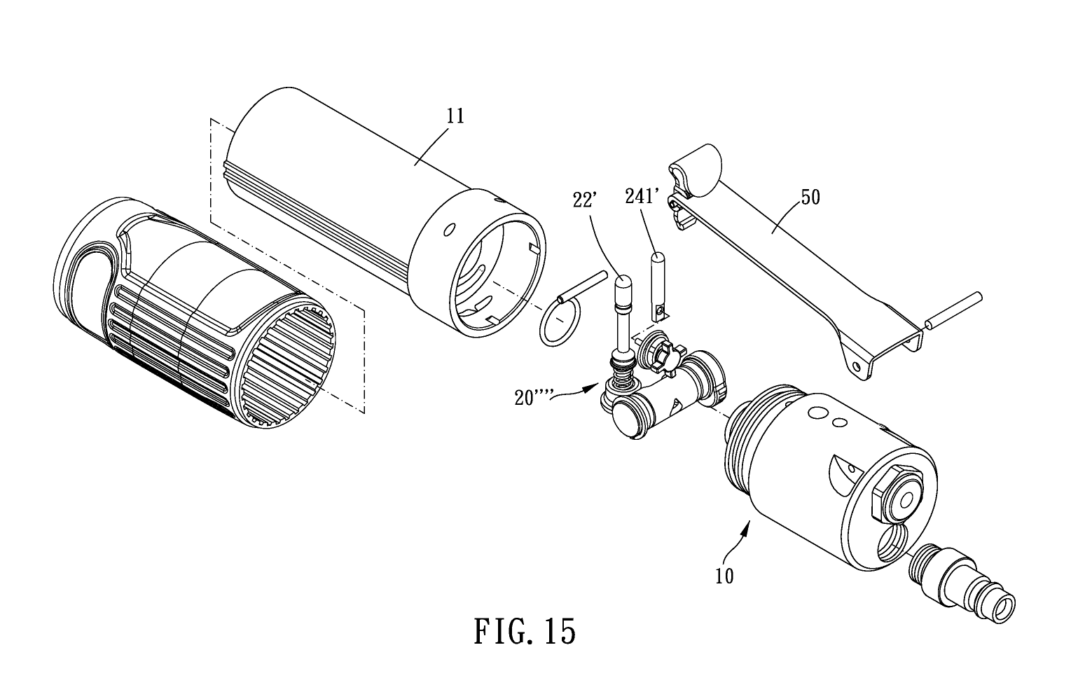

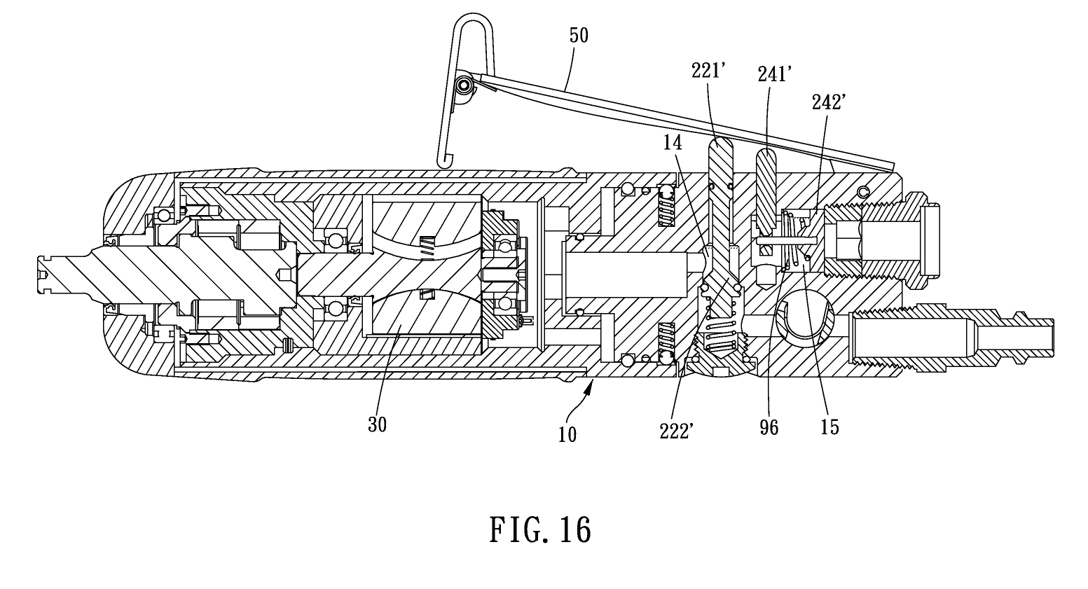

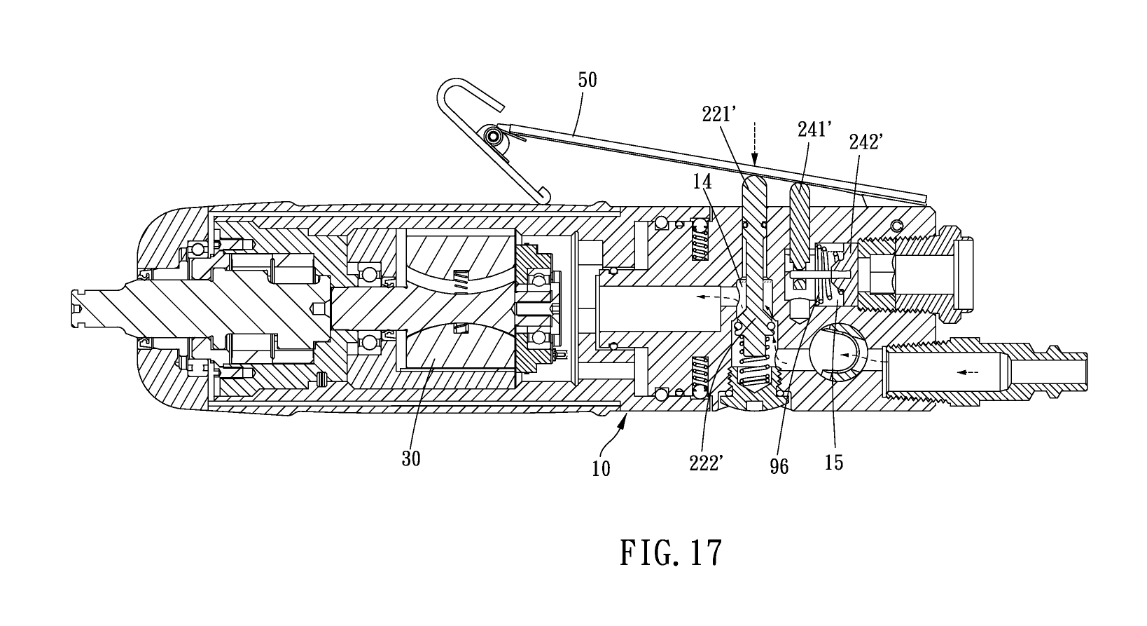

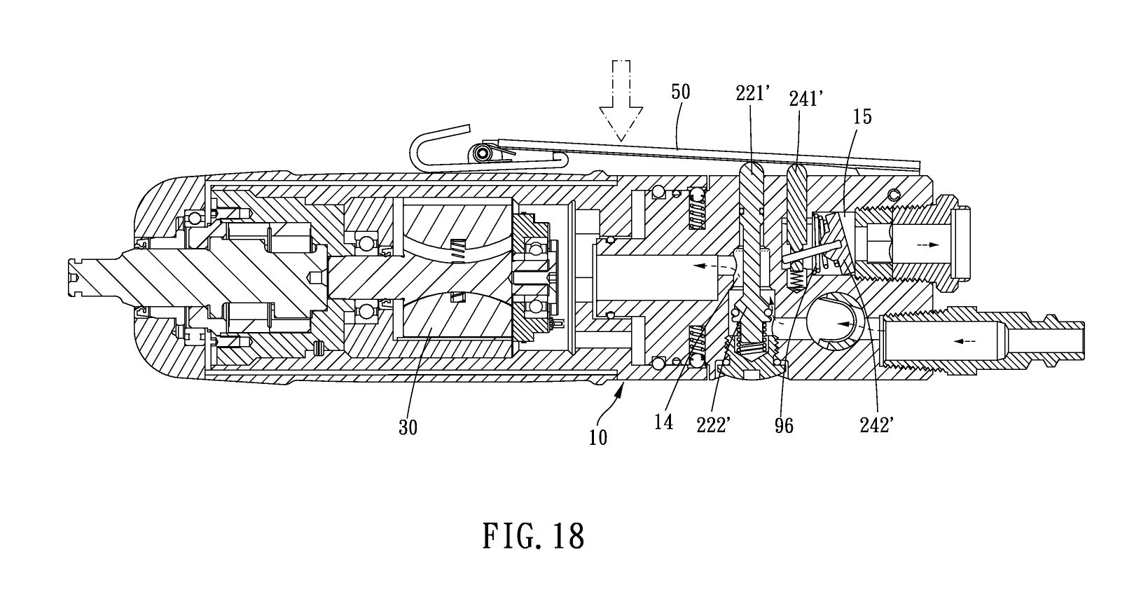

FIGS. 15 to 18 show a double-valve mechanism according to a fifth preferred embodiment of the present invention. Compared to the fourth preferred embodiment, a double-valve mechanism 20″″ in this embodiment further includes an entrance control vale 22′ having an inlet rod 221′ and an inlet plug 222′. The inlet rod 221′ is radially disposed through the main body 10 and movable between a first position and a second position. The inlet plug 222′ and the inlet rod 221′ are in a co-movable relationship. When the inlet rod 221′ is located in the first position, the inlet plug 222′ seals the entry of the inlet passage 14; when the inlet rod 221′ moves from the first position toward the second position, the inlet plug 222′ unseals the entry of the inlet passage 14. More specifically, in this embodiment, before the lever 50 is depressed, the inlet rod 221′ is located in the first position and one end of the inlet rod 221′ radially abuts against the lever 50, and the outlet rod 241′ is located in the third position and the entrance passage 12 is pneumatically uncommunicated with the inlet passage 14 and the exhaust passage 13 is pneumatically uncommunicated with the outlet passage 15; when the inlet rod 221′ moves from the first position toward the second position, the sealed entry of the inlet passage 14 is unsealed in advance and the outlet rod 241′ moves from the third position toward the fourth position so as to then unseal the sealed exit of the outlet passage 15. As such, the entrance passage 12 and the inlet passage 14 are pneumatically communicated and the exhaust passage 13 and the outlet passage 15 are pneumatically communicated. When the inlet rod 221′ moves from the second position toward the first position, the outlet plug 242′ seals the exit of the outlet passage 15 in advance, and then the inlet plug 222′ seals the entry of the inlet passage 14. Whereby, the advantages like those in the first preferred embodiment can also be achieved.

Given the above, the double-valve mechanism can block both the exhaust and entrance air so that pressurized air is completely blocked and the stop of the tool is more effectively ensured after the double-valve mechanism is closed, which is better than that in using only an entrance or exhaust control vale.

In addition, gas leakage, due to tolerances between parts inside the tool, due to the tolerance between the entrance adaptors, or due to the tolerance of assembly of a cylinder, will not occur. As a result, the waste of pressurized air energy and defects of the tool will be avoided.

Furthermore, since no gas leakage occurs, none of noise and degradation of the output torsion of the tool is caused, and rotation of the tool, after the exhaust and entrance air has been blocked, is effectively avoided so that injury to the user can be prevented.

Additionally, with the exhaust air blocked first and the entrance air blocked thereafter, the rotation of the rotor can be quickly stopped, and over-screw and tooth collapse can be prevented.

Additionally, the first receiving hole may be covered with a detachable cover which can be mounted or dismounted by a tool, such that it is easy to maintain or replace the entrance control vale. Besides, the exhaust passage may be mounted with a detachable cover, such that it is easy to maintain or replace the exhaust control vale.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A double-valve mechanism, adapted to mount in a main body of a pneumatic tool, the main body including an exhaust passage, an outlet passage, an entrance passage and an inlet passage, the exhaust passage adapted for exhausting air outside, the outlet passage and the exhaust passage being communicated, the entrance passage and the inlet passage being communicated, an entrance control vale of the double-valve mechanism being located between the entrance and inlet passages, an exhaust control vale of the double-valve mechanism being located between the outlet and exhaust passages, the double-valve mechanism being operable from outside of the main body to move the entrance and exhaust control vales in a single operation, the double-valve mechanism being movable relative to the main body so as to selectively seal an entry of the inlet passage via the entrance control vale and seal an exit of the outlet passage via the exhaust control vale so that the inlet and outlet passages are pneumatically uncommunicated with the entrance and exhaust passages respectively.

2. The double-valve mechanism of claim 1, wherein the main body further includes a cylinder, a first receiving hole and a second receiving hole, the cylinder is formed with a chamber, the inlet passage and the outlet passage are pneumatically communicated with the chamber, and the second receiving hole is located between the first receiving hole and the outlet passage and communicated with the first receiving hole, wherein:
the entrance control vale is movably disposed through the first receiving hole and axially movable between a first position and a second position, in a substantially gastightly-sealed relationship with a circumferential surface in the first receiving hole, one end thereof extending from an opening of the first receiving hole to outside the main body, and the other end thereof selectively sealing the entry of the inlet passage; and
the exhaust control vale is movably disposed through the second receiving hole, one end thereof and the entrance control vale being co-movable, and the other end thereof adapted to selectively seal the exit of the outlet passage;
wherein when the entrance control vale located in the first position, the entrance control vale seals the entry of the inlet passage so that the entrance passage is pneumatically uncommunicated with the inlet passage and the exhaust control vale seals the exit of the outlet passage so that the exhaust passage is pneumatically uncommunicated with the outlet passage, when the entrance control vale moves from the first position toward the second position, the entrance control vale unseals the entry of the inlet passage so that the entrance passage is pneumatically communicated with the inlet passage and the exhaust control vale moves away from the exit of the outlet passage so that the exhaust passage and the outlet passage are pneumatically communicated, when the entrance control vale moves from the second position toward the first position, the exhaust control vale seals the exit of the outlet passage in advance and the inlet control vale then seals the entry of inlet passage.

3. The double-valve mechanism of claim 2, further include a first elastic member disposed between the entrance control vale and the main body and a second elastic member disposed between the exhaust control vale and the main body.

4. The double-valve mechanism of claim 2, wherein the entrance control vale includes an inlet rod and an inlet plug disposed at one end of the inlet rod, a recess is radially formed on the inlet rod, and the exhaust control vale includes an outlet rod and an outlet plug disposed at one end of the outlet rod;
wherein when the entrance control vale is located in the first position, one end of the outlet rod abuts against a portion near a periphery of the opening of the recess and the inlet plug and the outlet plug respectively seal the entry of the inlet passage and the exit of the outlet passage, when the entrance control vale is located in the second position, the end of the outlet rod reaches inwardly into the recess and the inlet plug and the outlet plug respectively unseal the entry of the inlet passage and the of the exit outlet passage.

5. The double-valve mechanism of claim 2, wherein the entrance control vale includes an inlet rod and an inlet plug disposed at one end of the inlet rod, a recess is radially formed on the inlet rod, and the exhaust control vale includes an outlet rod and an outlet plug disposed at one end of the outlet rod;
wherein when the entrance control vale is located in the first position, one end of the outlet rod reaches into the recess and the inlet plug and the outlet plug respectively seal the entry of the inlet passage and the exit of the outlet passage, when the entrance control vale is located in the second position, the end of the outlet rod abuts against a surface outside the recess of the inlet rod and the inlet plug and the outlet plug respectively unseal the entry of the inlet passage and the exit of the outlet passage.

6. The double-valve mechanism of claim 4, wherein the inlet rod includes a head portion having a hole and a body portion whose one end is received in the hole, one end of the head portion extends outside the main body and the other end thereof includes a necked section, and a third elastic member is disposed in the hole and between the head portion and the body portion;
wherein when the entrance control vale moves from the first position toward the second position, the necked section of the head portion pushes the exhaust control vale so that the exhaust passage and the outlet passage are pneumatically communicated and the head portion drives the body portion moving so that the entrance passage and the inlet passage are pneumatically communicated.

7. The double-valve mechanism of claim 5, wherein the inlet rod includes a head portion having a hole and a body portion whose one end is received in the hole, one end of the head portion extends outside the main body and the other end thereof includes a necked section, a third elastic member is disposed in the hole and between the head portion and the body portion;
wherein when the entrance control vale moves from the first position toward the second position, the necked section of the head portion pushes the exhaust control vale so that the exhaust passage and the outlet passage are pneumatically communicated and the head portion drives the body portion moving so that the entrance passage and the inlet passage are pneumatically communicated.

8. The double-valve mechanism of claim 2, further including an open/close control assembly mounted to the main body and located within the entrance passage, and adapted to selectively interdict or uninterdict the entrance passage.

9. The double-valve mechanism of claim 8, wherein the open/close control assembly includes a shaft movable relative to the main body and a block portion connected to the shaft, and the shaft is selectively rotated to drive the block portion to interdict or uninterdict the entrance passage.

10. The double-valve mechanism of claim 1, wherein the exhaust control vale has an outlet rod and an outlet plug, the outlet rod radially disposed through the main body and movable between a third position and a fourth position, the outlet plug and the outlet rod are in a co-movable relationship, when the outlet rod is located in the third position, the outlet plug seals the exit of the outlet passage, when the outlet rod moves from the third position toward the fourth position, the outlet plug unseals the exit of the outlet passage.

11. The double-valve mechanism of claim 10, wherein the outlet plug and the outlet rod are co-movable via a linkage rod, a fourth elastic member is disposed in the outlet passage, the fourth elastic member is located between the outlet rod and the outlet plug, and the fourth elastic member urges the outlet plug to move toward the exit of the outlet passage so as to seal the exit of the outlet passage.

12. The double-valve mechanism of claim 10, wherein the entrance control vale has an inlet rod and an inlet plug, the inlet rod is radially disposed through the main body and movable between a first position and a second position, the inlet plug and the inlet rod are in a co-movable relationship, when the inlet rod is located in the first position, the inlet plug seals the entry of the inlet passage, when the inlet rod moves from the first position toward the second position, the inlet plug unseals the entry of the inlet passage.

13. The double-valve mechanism of claim 11, wherein the entrance control vale has an inlet rod and an inlet plug, the inlet rod is radially disposed through the main body and movable between a first position and a second position, the inlet plug and the inlet rod are in a co-movable relationship, when the inlet rod is located in the first position, the inlet plug seals the entry of the inlet passage, when the inlet rod moves from the first position toward the second position, the inlet plug unseals the entry of the inlet passage.

14. A pneumatic tool, including one of the double-valve mechanism of claim 2, further including:
a main body, including a cylinder, an entrance passage, an exhaust passage, an inlet passage, an outlet passage, a first receiving hole and a second receiving hole, the cylinder formed with a chamber, the chamber being pneumatically communicated with the inlet passage and the outlet passage, the second receiving hole located between the first receiving hole and the outlet passage and pneumatically communicated with the first receiving hole;
a rotor, rotatably disposed in the cylinder and received in the chamber; and
a tool assembly, rotatably received in the main body and in a rotational cooperative relationship with the rotor;
wherein the entrance passage is adapted to receive pressurized air, when the entrance control vale is located in the first position, the entrance passage is pneumatically uncommunicated with the inlet passage and the exhaust passage is pneumatically uncommunicated with the outlet passage, when the entrance control vale moves from the first position toward the second position, the entrance passage and the inlet passage are pneumatically communicated and the exhaust passage and the outlet passage are pneumatically communicated so that the pressurized air flows into the chamber via the inlet passage to drive the rotor rotating and then the pressurized air exhausts outside via the exhaust passage, when the entrance control vale moves from the second position toward the first position, the exhaust control vale seals the exit of the outlet passage in advance and the inlet control vale then seals the entry of inlet passage.

15. A pneumatic tool, including one of the double-valve mechanism of claim 10, further including:
a main body, including a cylinder, an entrance passage, an exhaust passage, an inlet passage, an outlet passage, a first receiving hole and a second receiving hole, the cylinder formed with a chamber, the chamber being pneumatically communicated with the inlet passage and the outlet passage, the second receiving hole located between the first receiving hole and the outlet passage and pneumatically communicated with the first receiving hole;
a rotor, rotatably disposed in the cylinder and received in the chamber; and
a tool assembly, rotatably received in the main body and in a rotational cooperative relationship with the rotor;
wherein the entrance passage is adapted to receive pressurized air, when the outlet rod is located in the third position, the entrance passage is pneumatically uncommunicated with the inlet passage and the exhaust passage is pneumatically uncommunicated with the outlet passage, when the outlet rod moves from the third position toward the fourth position, the entrance passage and the inlet passage are pneumatically communicated and the exhaust passage and the outlet passage are pneumatically communicated so that the pressurized air flows into the chamber via the inlet passage to drive the rotor rotating and then the pressurized air exhausts outside via the exhaust passage.
